(19) United States
(12) Patent Application Publication
(10) Pub. No.: US 2007/0150233 A1
(43) Pub. Date: Jun. 28, 2007

(54) V.A.C.T. or visual associative comparison technique: A method and system for evaluating human compatibility and/or performance potential with a categorized iconic or alphanumeric representation driven by a uniform and consistent dataset

(76) Inventors: Mark Edward Firehammer, Easthampton, MA (US); Patricia Ann Gates, Easthampton, MA (US)

Correspondence Address: Mark Edward Firehammer, 11 Picard Circle, Easthampton, MA, 01027, US

(21) Appl. No.: 11/643,121

(22) Filed: Dec. 21, 2006

Related U.S. Application Data
(60) Provisional application No. 60/753,465, filed on Dec. 22, 2005.

(51) Int. Cl. G06F 19/00

(52) U.S. Cl. 702/180; 702/1; 702/127

(57) ABSTRACT

V.A.C.T. about relationship compatibility potential, by displaying to a subject individual, a data driven representation of multiple relationships simultaneously. The subject individual can draw experience oriented conclusions by associating the objective, visually presented data based differences in those relationships with the subjective, remembered differences of those same relationships. Once identified, specific combinations can be sought or avoided when choosing new relationships. To accomplish the described usefulness, one places a group of relations known to a single subject individual on one axis of a table and names of comparison categories on the other axis. Each relationship is objectively represented by using person specific sets of data points generated by a consistently applied system or systems of analysis. The cells of the table are populated with an iconic and/or alphanumeric set, keyed to both individual's specific data points and data point combinations, as well as to the cross relationship data point combinations, resulting in the objective, data based visual representation of every individual's relationship to the subject individual.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISC APPENDIX

Not Applicable

### BACKGROUND OF THE INVENTION

When applied to the task of enhancing human relationship potential, this invention is a method and system that presents an opportunity for an individual to draw personal conclusions regarding the potential for compatibility in possible and existing human relationships, by comparing the subjective memories of known relationships to an objective data oriented representation of those same relationships. This application is filed under Patent Class 702 DATA PROCESSING: MEASURING, CALIBRATING, OR TESTING Subcategory 1A: Measurement System in a Specific Environment, and the specific environment that the system is applied to, is the environment that is represented by individual human relationships. This invention is a system designed to give you more information from your own experiences which is highly relevant when making relationship choices. The object of this invention is to speed the process of identifying specific combinations of the hidden human qualities, characteristics and tendencies, hereafter referred to as factors, that are at play in any relationship, for the purpose of identifying the combinations that represent the highest probability for a successful long-term result for an individual user, based upon an analysis of the combinations of the hidden factors that were in place in previously experienced relationship results.

The U.S. Census Bureau reports that 50% of all marriages in the United States end in divorce within the first seven years. The explosive popularity of online dating since 1999 has not been shown to have had a measurable effect on the divorce statistics. Books, compatibility tests, self-help materials and expert opinions have been around for even longer and haven't made a statistical difference either. These represent the current state-of-the-art of dating and relationship management and what makes all of those things ineffective toward increasing population wide performance is that they are all attempts to generally educate the population, while exponentially increasing the opportunities to meet potential partners through the use of cell phone and internet technologies. None of them offers any additional information that is specifically relevant to the individual's experience. With regard to relationship success, statistical performance across a population is a measurement of the combined experiences of individuals and because the definition of an ideal relationship will vary from person-to-person, the best solution to the problem of increasing performance is one that creates the opportunity for individuals to increase their understanding of their own experiences. V.A.C.T. achieves this by using the individual's own relationship specific data to create an opportunity to identify patterns within their own successes and disappointments. That information is useful to the unique process and experience of the individual who is naturally trying to learn from that experience in an attempt to move toward more success and less disappointment.

When applied to the task of analyzing interactive human performance potential, the system works in the exact same way but with one exception. Instead of a selected individual's opinion of past relationship experiences being the reference for the performance preference, the standard or reference for the performance preference would be the statistical performance data that is gathered as part of the process of whatever organizational endeavor V.A.C.T. is being applied to. For example; the player and team performance statistics gathered by sporting teams and franchises, individual and group sales performance statistics gathered by profit oriented business organizations. All of this information could be compared to a V.A.C.T. result to identify patterns that represent the most historically successful combinations for a specific and repeated interaction.

### BRIEF SUMMARY OF THE INVENTION

V.A.C.T. is essentially a presentation method. What it presents is objectified data that represents any number of one individual's known relationships simultaneously. The actual data that is used can come from any system that is commonly used to describe or categorize human beings and aspects of their behavior, such as personality profile tests, fingerprint analysis, astrology, and numerology etc. To objectify the data means we discard the interpretation of it because in this application the data is not meant to give a user advice. Instead, we reduce the results to specific data points or values, in whatever categories the chosen system will allow with regard to human behavior or tendency. That data is then used to drive a visually oriented result creating a visual fingerprint of different known relationships for a single individual, which can then be compared to the remembered similarities and differences experienced in those relationships. Ideally the categories should be divided into two families, one family of categories representing the factors of each individual, and the second family of categories representing the combined factors of each individual with one selected individual. The test results data for each category is reduced to ranges within the possible results. For example, if a given testing system uses a score for each data point that ranges from 1 to 100, you could divide that score into four groups of 25 each, a score of 1 to 25=A, 26 to 50=B, 51 to 75=C, 76 to 100=D. Once the available test data is reduced to these manageable ranges, an arbitrary image can be selected to represent each range in categories representing individual factors. In categories representing combined factors, each possible combination is also assigned an arbitrary image. A table is then populated with those images based upon the combined data points of each individual relationship pair, with each table row representing a relationship between each person in the subject group with the same selected individual. When that process is completed, the data represents a unique visual fingerprint of each relationship in the subject group, relative to the selected individual, which can now be compared to the existing opinions that selected individual has of those relationships.

### BRIEF DESCRIPTION OF THE SEVERAL VIEWS OF THE DRAWING

FIG. 101, is a data source example, The Myers Briggs Type Test

FIG. 102 is a subject group consisting of a selected individual and group of individuals known to the selected individual.

FIG. 103a represents the data source results from administering the Myers Briggs Type Test from FIG. 101 to the subject Group of FIG. 102.

FIG. 103b, the test results of the Selected Member from FIG. 102 Subject Group, reduced to a uniform database table format.

FIGS. 103c, d, e and f, are the individual test results of each Group member of the FIG. 102 Subject Group, reduced to a uniform database table format.

FIG. 104 contains the Result Range Alphanumeric Indicators. The example data source, FIG. 101, has a 100 point resolution which is reduced to five ranges within that resolution and each is assigned an alphanumeric indicator.

FIG. 105 is an Icon Set. The final V.A.C.T. results are made up of combinations of these icons. In this example the icons represent the difference between, or sameness of, two separate result ranges.

FIG. 106, are the possible results combinations icon assignments. Each possible combination of results as defined by the Result Range Alphanumeric indicators in FIG. 104 is assigned the appropriate icon from FIG. 105.

FIG. 107, a V.A.C.T. result grid using all the above described example components.

### DETAILED DESCRIPTION OF THE INVENTION

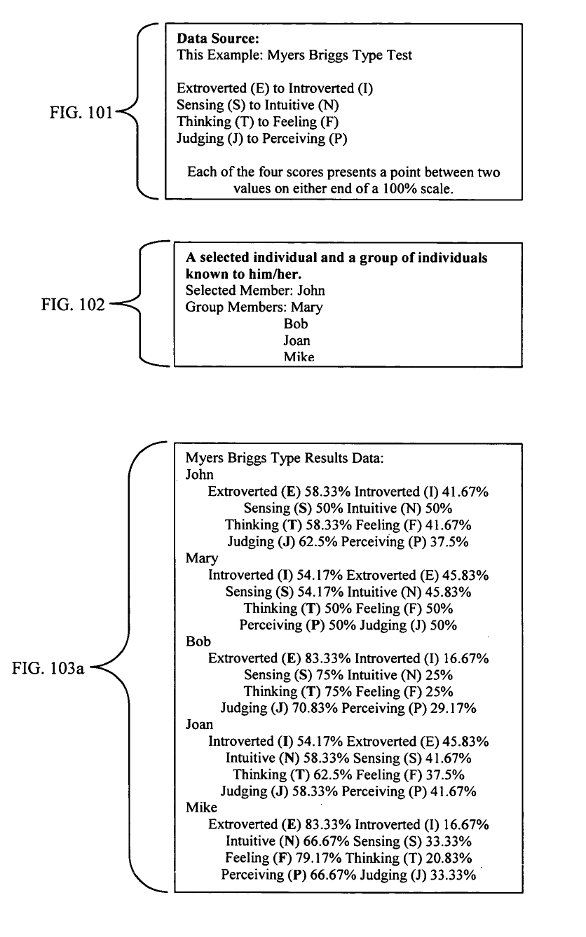

As described in the previous section entitled brief summary of the invention, V.A.C.T. is essentially a presentation method. This method can be adapted to accommodate any type of data that is used to describe, categorize or understand human beings. This detailed description of the invention and its proper implementation will refer to the well known Myers Briggs Type Test, FIG. 101, as the example data source throughout the description. Each of the following steps involving multiple components can be performed manually by anyone with the following understanding for creating the end result on paper or any other means of transcription. The same steps and components can be coded into a computer program or web application utilizing already existing software and hardware components to achieve the result.

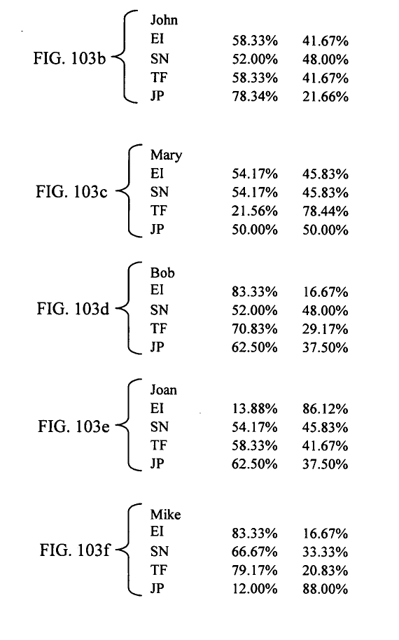

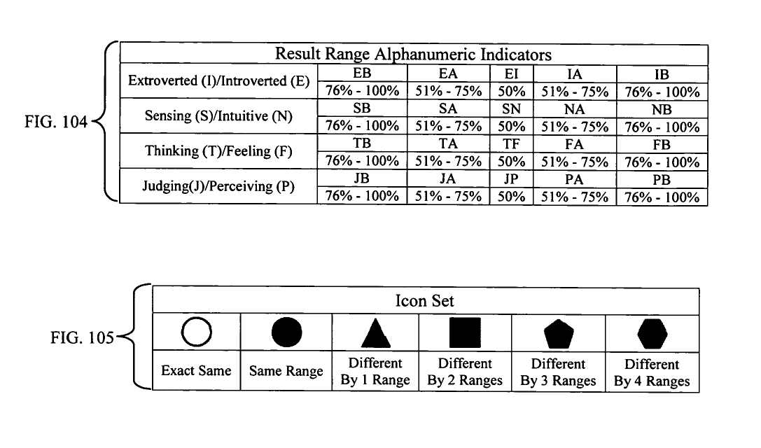

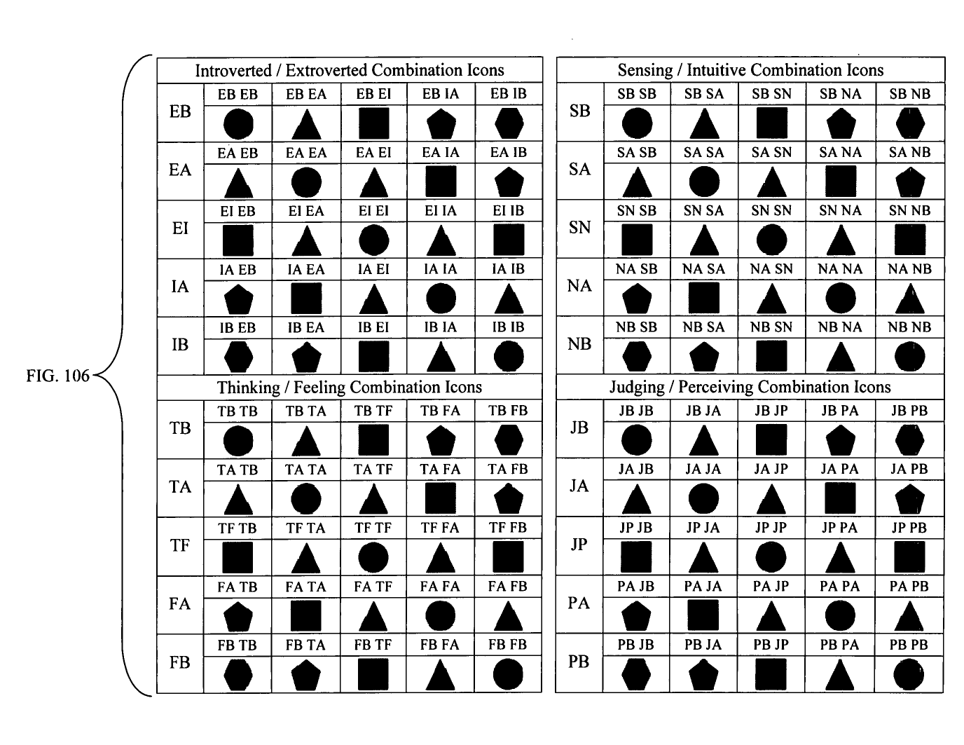

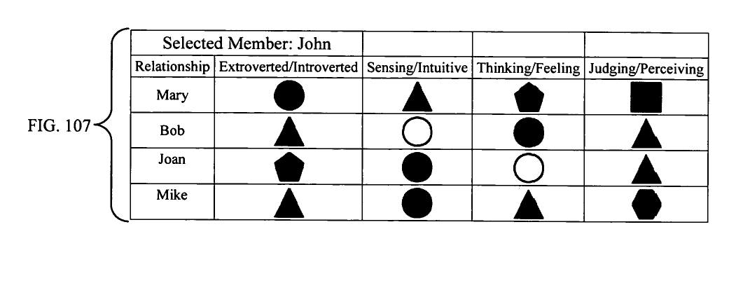

This invention is a method and system that presents an opportunity for an individual to draw personal conclusions regarding the potential for compatibility in possible and existing human relationships, by comparing the subjective memories of known relationships to an objective data oriented representation of those same relationships. To that end the process requires an objective source of data that describes or quantifies members of the Subject Group, for this example as previously stated we are using the Myers Briggs type test, FIG. 101, and each member of the Subject Group FIG. 102, would take the test, producing the results that represent the entire group, FIG. 103a. The groups results are then converted into a separate and uniform database records representing each member of the group individually, illustrated in FIGS. 103b, c, d, e, and f. In order to prepare to visually represent the relationship combinations of the Subject Group FIG. 102, the data source needs to be broken down into a manageable number of ranges, and each range assigned an alphanumeric indicator. The example dataset of FIG. 101 the Myers Briggs type test, results in four values each expressed on a 100% scale. FIG. 104 presents that breakdown and the assigned alphanumeric indicators. FIG. 105 is the icon set used for this example. Starting on the left of the table, the open circle will be used to represent two different results that are the exact same numeric value, and within the same range for a particular value. The next icon, the closed circle, will be used to represent two different results in the same range for a particular value. Each subsequent icon, moving to the right of the 2 circles, starting with the triangle, represents a range difference that increases by one with each icon. In this simple example, the more sides there are to the icon, the greater the difference in range between two different results of a particular value in the final result. Starting with the triangle which represents one range difference, the square equals two ranges, and so on. The effectiveness of this example icon set would be enhanced with the addition of differences in color from icon to icon. It is presented here in black-and-white, for simplicity and to conform to the stated requirements of this document. The next step is to create the table that is shown in FIG. 106 where each quadrant of the table is populated with every possible alphanumeric pair as defined in FIG. 104. Immediately below each possible alphanumeric pair is the icon from FIG. 105 that represents the range difference represented by that pair. The final visual result is produced with the following sequence; from the test results table of the Selected Member John, FIG. 103b, and the first group member, Mary, FIG. 103c, note the larger percentage in that row and the E or I value it represents. If the EI value is 50% 50% the value EI will be carried forward to the next step. In this example John, FIG. 103b, is an E 58.33% and Mary, FIG. 103c, is an E 54.17%. You now refer to FIG. 104 to identify the equivalent Result Range Alphanumeric Indicators for each. In this example John is an E 58.33% which is within the EA range. Mary is in E 54.17% which is also within the EA range. The relationship between Selected Member John and Group Member Mary represents an EA EA match. You then look at that pair in FIG. 106, to identify which icon represents an EA EA match. That icon is placed in the final result grid cell that represents the EI relationship match result for John and Mary as shown in FIG. 107 Repeat the process to fill the entire grid with the icons that represent each pairing, for each value, in each relationship in the Subject Group.

How is this useful? The paragraphs of this section will explain how human relationships represent an environment made up of combinations of visible as well as invisible factors brought to the relationship by each person. While human beings base their relationship choices mostly on the visible variables, the experiences within those relationships are subject to the combinations of the hidden variables as well. We ultimately judge the experience as either acceptable or unacceptable, without any real awareness or understanding of the combinations of hidden variables that contributed to the experience. Because those hidden variables can be measured and quantified in any number of ways, the opportunity to compare those judgments of known past experiences to a visual representation of the hidden variables at play in those experiences, can be highly useful in the process of understanding past and existing relationships as well as choosing new relationships.

Here is the problem that the invention V.A.C.T. overcomes. We as a society have demonstrated a collective difficulty in reliably choosing long-term relationships that demonstrate lasting levels of compatibility. Divorce rates hover around 50%, and a great number of the marriages that endure fall short of what even low expectations would call a good example. This shared problem has led to a commonly held belief system that usually sounds something like this; “A good relationship is hard work.” Or, “Good relationships are the result of hard work, tremendous personal sacrifice and compromise.” What fueled the development of this invention was that people who were clearly participating in extraordinarily compatible relationships, when asked to confirm the commonly held belief, that their relationship success is a product of extraordinary hard work and personal sacrifice, they couldn't. In fact their answers were just the opposite. They revealed that the extraordinarily satisfying relationship was quite effortless in comparison to other less satisfying experiences they have had. If you then ask them how they got that? They attributed their success mostly to luck. We also noted that the extraordinarily satisfying relationships, were not limited to a specific demographic or socioeconomic group, and the participants were not perceivably any better than the people in unsatisfying relationships. We took this as a possible indication that it was the combinations of people that were good, not the people themselves.

What we knew to be true was that the full spectrum of possible relationship outcomes exists, ranging from the really unsatisfying relationships to the extraordinarily satisfying relationships. As already stated, we also learned that the extraordinarily satisfying relationships tended to defy the commonly held belief that hard work and sacrifice is the method to achieving them. So with a perspective from Albert Einstein to guide us, we began thinking about relationships from an entirely different point of view. “Problems cannot be solved at the same level of awareness that created them.”—Albert Einstein “Not everything that can be counted counts and not everything that counts can be counted.”—Albert Einstein

Our new point of view began with these basic beliefs; extraordinarily satisfying relationships are easy to be in, seemingly impossible to choose, and all people are equally equipped to be in one. In order to analyze the difference between unsatisfying relationships and extraordinarily satisfying relationships, we begin thinking of relationship as an environment, composed of all the factors that two people bring to the relationship. Our challenge was this; if a relationship is an environment consisting of the factors brought together by two people and we assume that couples are an obviously positive match of the visible and choose-able factors, beliefs and values that represent them individually, then what information contributes to the difference between the couple that experiences an unsatisfactory long-term result, and a couple that experiences an extraordinarily satisfying long-term result?

The first step in answering that question was excepting that whatever that information is, it is not visible to us in the way that the factors we chose are visible to us. So the invisible ingredients are brought to the relationship along with the visible ingredients we chose in a partner. We eventually experience the results of the combination of those invisible ingredients brought together in that relationship, at which point we judge for ourselves where the experience falls between really unsatisfying and extraordinarily satisfying. Our conclusion: there are visible and invisible factors at play. If the visible factors are for the most part right for both parties, and there is still a unsatisfying result then the invisible factors must be in part responsible. “In the middle of difficulty lies opportunity.”—Albert Einstein

Einstein's theories of relativity and other important contributions to quantum physics has given human beings an understanding of the structure of things that has allowed us to control outcomes according to our needs and desires in every area of human endeavor except relationships. Perhaps this is because relationship fulfillment and satisfaction is considered to be a subjective experience. Meaning that what is satisfying for you is not necessarily going to be satisfying for me, so therefore in the case of relationship success, objective science can't be used to reliably understand and control satisfying relationship outcomes due to the fact that what is considered satisfying is not a constant across a population. It may, however, be a constant on many levels over one individual's lifetime. Thus we chose to make the individuals experience the source of the value standard. Quantum physics basically describes how everything that exists in the environment known as the universe, which includes life on Earth, is the result of the available ingredients, in this case matter, energy and the principles that govern them, getting organized into the combinations that work to support every possible result that exists within life, and that includes humans. By considering relationships to be a reflection of the universe and life, an environment with a fixed set of available ingredients that are organized into the combinations that work to result in every possible outcome, ranging from extraordinarily satisfying to unsatisfying, it becomes possible to imagine being in control of the outcome by devising a system or tool that enhances our ability to reveal the ingredients within the specific relationship environments known to any individual, well enough for that individual to understand the combinations that work to deliver their preferred experience.

Quantum physics gave us the understanding that the building blocks of the ingredients that allow everything to be, exist on a level beyond the limits of our natural sensory abilities. This unquestioned scientific principle made it reasonable, and sensible for us to except that the relationship environments that we choose to participate in, are more than just a product of what we see and choose, and in fact are also subject to the combinations of invisible, not choose-able and not changeable ingredients that we each bring to that environment. Of course with human relationship ingredients we are not talking about atoms and elements, particles and waves, but we are talking about factors that, though not on the surface, can be tested for and quantified in a variety of known ways.

This means that the hidden information is far from new. Astrology and numerology are examples of systems used to define human beings on many levels. There are many well-known personality profiling tools like the Myers Briggs personality type indicator, or the DiSC Profile Personality Test, that are commonly used in the business world to help employers and managers to optimize the work environment by arranging the relationships appropriately according to the information the test results reveal. Of course these tests are not practical for choosing personal relationships for several reasons; the necessity to test every potential partner, the cost of those tests if you could test them all, and then the need to be able to interpret the data relative to the specific subjective needs and desires that you have for your relationship. In addition to uniformly generated results, what all of these systems have in common is that they also come with a recommendation based upon the experts understanding of what the results represent. As a population, we have not demonstrated a willingness to defer to expert opinions when making personal relationship choices.

There were two keys to making broad and inclusive use of this very real hidden information. The first was to favor systems of analysis that do not require expensive and impractical testing, the second key was to remove the experts recommendation, or the need to become an expert in the interpretation of the data points, and instead create a visual representation driven by the same data points so that a user can simply see what combinations of the hidden information are in place in relationships they already have formed an opinion about. The user becomes the expert, based upon the full range of his or her experience. The idea is that the relationships that were satisfying for you will have some combinations of data points in common, and the relationships that were unsatisfying for you will have some combinations of data points in common as well. Identify those two groups of combinations and you are in control of the outcome when making new choices.

This is what V.A.C.T. accomplishes. Creating a measuring system out of the purely objective data that represents your own specific known relationships, and then using the data representation to measure and validate your own existing opinion of those relationships. Once your satisfying and unsatisfying experiences are validated, by the repeating patterns that represent each end of the quality spectrum, you know the combinations that work for you and can seek them out in new relationships using the same system, confident that your own past experience revealed them to you. Of course this value is not just realized in the selection of new relationships. Existing relationships may also benefit from an understanding of the combinations at work, in that if there are combinations that don't work for you, in an existing relationship, and those combinations are manifesting similar results, an understanding of them can lessen the impact. Additionally, the same system can be applied to an analysis of key pairings responsible for meaningful productivity within just about any organization. A good example would be to generate the objective dataset for every quarterback/center pair, from any given period of football history, and then associate those results with the performance statistics of those pairs, in an effort to identify any combinations that are statistically winning combinations. V.A.C.T represents a valuable opportunity to mine the data that represents the human relationship environment, for the combinations that work to support the greatest success in any trackable endeavor from successful and supportive marriages to winning sports and business organizations.

We claim that our invention is:

1. A method that creates a visual result allowing for any subject individual, to form an additional level of personal opinion about the potential for relationship compatibility;
by using a system or systems of analysis such as, but not limited to, astrology or numerology, whereby all the available data points can be used to map the objective data oriented differences between multiple individuals and all possible pairs of those individuals, by using specific data points and combinations of data points to define multiple variations within multiple categories, where each category represents a different aspect of a relationship interaction as can be described by the chosen system of analysis;
and then applying the system of analysis to any group of individuals known to a subject individual in order to generate the necessary set of data points representing each individual in the selected group including the subject individual;
whereby the available data points can be used to produce a presentation of visual results, consisting of categorized icons or alphanumeric sets that are keyed to data points and data point combinations of the individuals, as well as to the cross relationship data point combinations representing the relationship between each known individual and the subject individual;
in a table showing the combinations of the categorized icons representing each individual and their relationship to the subject individual;
so that the subject individual can associate the objective, relationship specific visual combinations with the subjective personal memory records of the same relationships;
in order to identify the combinations within the objective visual results, that consistently represent the most preferred and the least preferred of the known relationship experiences;
the understanding of which can be applied to the understanding and management of current relationships and the choice of future relationships.

2. The method of claim 1 wherein the necessary steps are performed by hand, by a person on behalf of themselves or on behalf of other persons.

3. The method of claim 1 wherein the necessary steps are performed by a person interacting with a computer application to get the necessary data to generate the visual results on behalf of themselves or on behalf of other persons.

4. The computer application of claim 3 comprising of;
a set or sets of categorized icons or alphanumeric sets hereafter referred to as visual results;
a database or databases;
the database table or tables for containing unique group member identifier and associated necessary data points as required by the method described in claim 1;
a database table or tables containing the data point association rules dictating which icon or icons to display in a given category for a specific relationship based upon data points or combinations of data points present in two different group member database records;
a user interface for importing or entering unique group member identifiers and necessary data points into the database tables;
a query and display module responsible for querying and displaying the categorized visual results, for each group individual's relationship to the subject individual.

5. The computer application of claim 3 wherein the necessary data points to be associated with each group member, in the database table or tables, are placed there by an integrated testing or calculating module programmed to utilize a user interface to allow for the gathering of the information required to generate and database the necessary data points.

6. The computer application of claim 3 wherein the computer application operates locally from a single client system.

7. The computer application of claim 3 wherein the computer application operates on a server system;
with client systems communicating with the server system via the Internet;
where the user interfaces that are necessary to allow users to access the application functionality and provide the information necessary to produce the visual results, are displayed in an HTML document, or similarly effective technology, provided by the server system.

8. The method of claim 1, wherein the necessary steps are taken to create a visual result giving an opportunity for organizations to further utilize existing data by associating past key relationship performance data, to the key relationship environment data, in search of relationship environment combinations that indicate a trend toward or away from increased productivity for the key relationships in a given endeavor.
